(19) United States
(12) Patent Application Publication
(10) Pub. No.: US 2018/0304638 A1
(43) Pub. Date: Oct. 25, 2018

(54) Ink Container and Inkjet Printer

(71) Applicant: Brother Kogyo Kabushiki Kaisha, Nagoya-shi, Aichi-ken (JP)

(72) Inventors: Akinari Ishibe, Nagoya-shi (JP); Masahiro Hayashi, Nagoya-shi (JP); Satomi Aizawa, Nagoya-shi (JP); Kazuteru Kojima, Nagoya-shi (JP)

(21) Appl. No.: 15/770,237

(22) PCT Filed: Nov. 18, 2016
(86) PCT No.: PCT/JP2016/084274

§ 371 Date: Apr. 23, 2018

(30) Foreign Application Priority Data
Nov. 20, 2015 (CN) 201520933380.4U

(51) Int. Cl. B41J 2/175

(52) U.S. Cl. CPC B41J 2/17553; B41J 2/17506

(57) ABSTRACT

An ink container for an inkjet printer includes an ink container body and a cover. The inkjet printer includes a printer body. The ink container body is configured to contain ink and includes a refill portion. The cover is configured to cover at least an area of the ink container body in which the refill portion is disposed and to pivot about a pivot axis between an opened position and a closed position with respect to the ink container body. When the cover is in the closed position, the refill portion is covered by the cover. When the cover is in the opened position, the refill portion is exposed. The pivot axis extends along a horizontal direction and being parallel to an attaching surface of the printer body. At least one of two side portions of the cover includes a handle.

### CROSS-REFERENCE TO RELATED APPLICATION

This application claims priority from Chinese Utility Model Application No. 201520933380.4, filed on Nov. 20, 2015, which is incorporated herein by reference in its entirety.

### TECHNICAL FIELD

The disclosure relates to an ink container and an inkjet printer including an ink container.

### BACKGROUND ART

Known inkjet printers typically print by ejecting ink from a recording head to a recording medium, such as a printing paper. Known inkjet printers typically include a main body and ink container that is fixed to a side surface of the main body. The ink container includes an ink container body and a cover pivotable between an opened position and a closed position with respect to the ink container body. The ink container body includes a handle. Before pouring ink into the ink container, the user may hold the handle to pivot the cover to the opened position. In the conventional inkjet printers, as depicted in FIG. 1, the handle is disposed only on one side, other than the front side, of the ink container body. The user may have some difficulties to open the cover if the cover is disposed on other sides, compared that the cover is disposed on the one side.

### DISCLOSURE OF INVENTION

### Solution to Problem

The present disclosure describes an ink container that may enable the user to open the cover from the front side or rear side of the ink container body.

According to an aspect of the disclosure, an ink container for an inkjet printer may include an ink container body and a cover. The inkjet printer may include a printer body. The ink container body may be configured to contain ink to be supplied to the printer body and may include a refill portion through which ink is refilled. The cover may be configured to cover at least an area of the ink container body in which the refill portion is disposed and to pivot about a pivot axis between an opened position and a closed position with respect to the ink container body. When the cover is in the closed position, the refill portion may be covered by the cover. When the cover is in the opened position, the refill portion may be exposed. The pivot axis may extend along a horizontal direction and may be parallel to an attaching surface, to which the ink container is to be attached, of the printer body. At least one of two side portions, which are opposite each other along the pivot axis, of the cover may include a handle.

### BRIEF DESCRIPTION OF DRAWINGS

Aspects of the disclosure are illustrated by way of example and not by limitation in the accompanying figures in which like reference characters indicate similar elements.

FIG. 1 is a perspective view depicting a conventional inkjet printer.

FIG. 2 is a perspective view depicting an inkjet printer in a preferred illustrative embodiment according to one or more aspects of the disclosure, in which the cover is closed.

FIG. 3 is another perspective view depicting the inkjet printer of FIG. 2, in which the cover is opened.

FIG. 4 is a perspective view depicting an ink container of the inkjet printer of FIG. 3, in which the cover is opened.

FIG. 5 is a sectional view depicting a portion of the ink container, illustrating one embodiment of the handle.

FIG. 6 is a sectional view depicting a portion of the ink container, illustrating another embodiment of the handle.

FIG. 7 is a sectional view depicting a portion of the ink container, illustrating another embodiment of the handle.

FIG. 8 is a sectional view depicting a portion of the ink container, illustrating another embodiment of the handle.

FIG. 9 is a sectional view depicting a portion of the ink container, illustrating another embodiment of the handle.

FIG. 10 is a sectional view depicting a portion of the ink container, illustrating another embodiment of the handle.

FIG. 11 is a perspective view depicting an inkjet printer in another preferred illustrative embodiment according to one or more aspects of the disclosure, in which the cover is closed.

FIG. 12 is another perspective view depicting the inkjet printer of FIG. 11, in which the cover is opened.

FIG. 13 is a perspective view depicting an inkjet printer in another preferred illustrative embodiment according to one or more aspects of the disclosure, in which the cover is closed.

FIG. 14 is a perspective view depicting an inkjet printer in another preferred illustrative embodiment according to one or more aspects of the disclosure, in which the cover is closed.

FIG. 15 is a perspective view depicting an inkjet printer in another preferred illustrative embodiment according to one or more aspects of the disclosure, in which the cover is closed.

FIG. 16 is a perspective view depicting an inkjet printer in another preferred illustrative embodiment according to one or more aspects of the disclosure, in which the cover is closed.

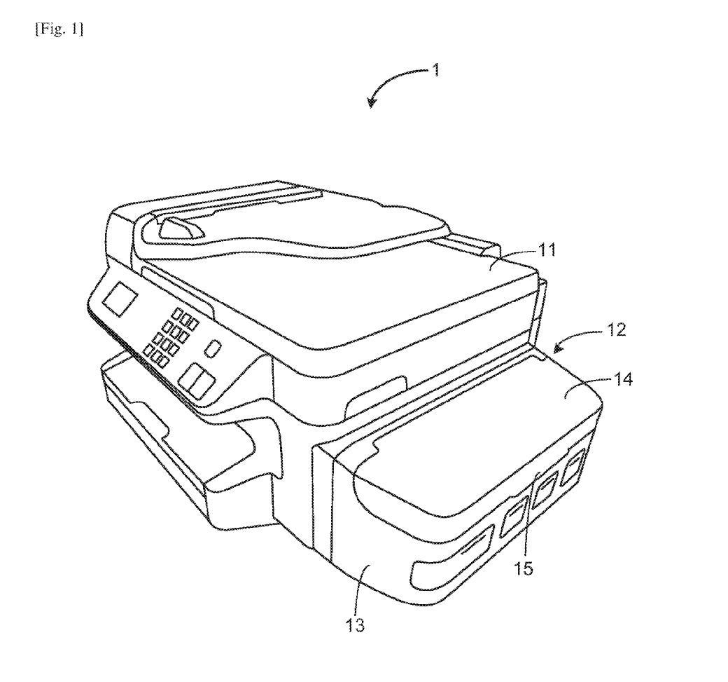

### BEST MODE FOR CARRYING OUT THE INVENTION

For a more complete understanding of the present disclosure, needs satisfied thereby, and the objects, features, and advantages thereof, reference now is made to the following descriptions taken in connection with the accompanying drawings. Hereinafter, illustrative embodiments of the disclosure will be described in detail with reference to the accompanying drawings. The terms “front”, “back”, “left”, “right”, “top” and “bottom” are used herein for the purpose of illustration and not of limitation. The terms “first” and “second” referenced herein are merely identification and do not have any other meaning, such as a particular order. For example, the term “first component” does not imply the presence of “second component”, and the term “second component” does not imply the presence of “first component”. The term “parallel”, “horizontal” and “perpendicular” referenced herein means substantially “parallel”, “horizontal” and “perpendicular”.

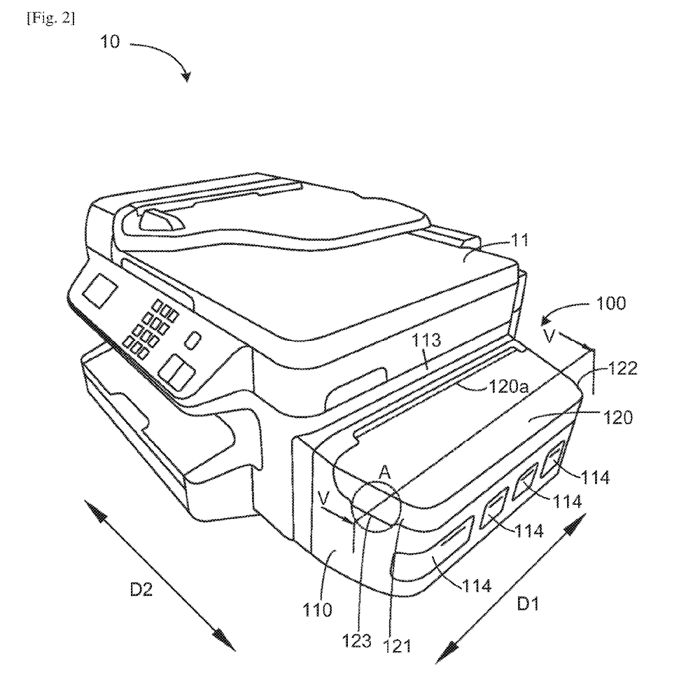

FIGS. 2-4 are perspective views depicting an inkjet printer 10 and an ink container 100 in a preferred illustrative embodiment according to one or more aspects of the disclosure.

The inkjet printer according to the disclosure may have various functions such as an image scanner function, a facsimile function and a copier function, in addition to a printing function. The printing function may include a double-sided image recording function capable of recording an image on both side of a recording sheet.

As depicted in FIG. 2, the inkjet printer 10 includes a printer body 11 and an ink container 100. The ink container 100 is fixed to or detachably attached to the printer body 11. The printer body 11 has a substantially rectangular parallelepiped shape. The ink container 100 is disposed on an attaching surface 113, which is a right side surface of the printer body 11, and extends rightward from the right side surface of the printer body 11. It should be appreciated that although the ink container 100 is disposed on the right side of the printer body 11 in the illustrated embodiment, the ink container 100 may be fixed or detachably attached to other portions of the printer body 11, according to the actual needs. It is also appreciated that although the ink container 100 is fixed to the printer body 11 in the illustrated embodiment, the ink container 100 may also be detachably attached to the printer body 11.

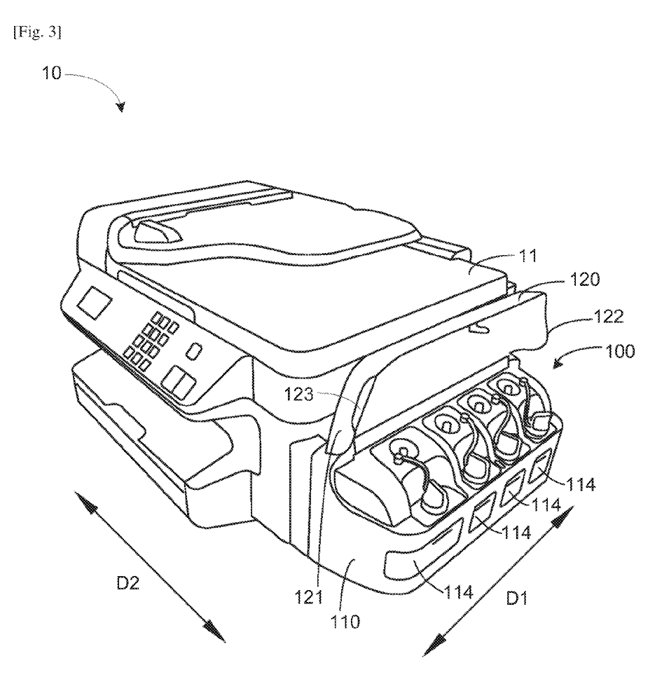

As depicted in FIGS. 2 and 3, the ink container 100 includes an ink container body 110 configured to contain ink to be supplied to the printer body 11. The ink container body 110 includes four ink containing portions 114, each of which is configured to contain ink of different colors, such as black, cyan, magenta, and yellow, to be used to record a color image. The ink container body 110 may include six, eight, or twelve ink containing portions 114 to record the color image using six, eight, or twelve colors of ink, respectively.

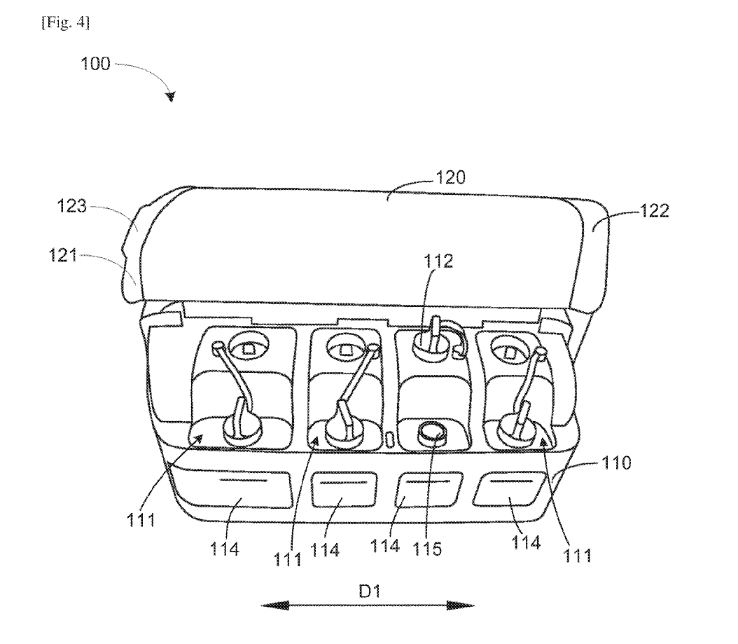

As depicted in FIG. 4, an upper surface of each of the ink containing portions 114 includes a refill portion 111, which protrudes from the upper surface and includes a tube, which allows the user to pour ink into the ink containing portion 114. The refill portion 111 not only includes a refill port 115, but also includes a sealing member 112 configured to seal the refill port 115 and prevent ink from evaporating or leaking.

As depicted in FIGS. 2-4, the ink container 100 further includes a cover 120. The cover 120 has a substantially plate shape and is connected to the ink container body 110 such that the cover 120 is pivotable about a pivot axis 120a. The pivot axis 120a extends along a horizontal direction and is parallel to the attaching surface 113, to which the ink container 100 is attached, of the printer body 11. In other words, the pivot axis 120a extends along a front-rear direction, i.e., D1 shown in FIG. 2, of the ink container 100. Specifically, the cover 120 is pivotable between a closed position and an opened position with respect to the ink container body 110. FIG. 2 depicts an inkjet printer in which the cover 120 is in the closed position, and FIGS. 3 and 4 depict an inkjet printer in which the cover 120 is in the opened position. When the cover 120 is in the closed position, the cover 120 covers the refill portion 111. When the cover 120 is in the opened position, the refill portion 111 is exposed. The user may pour ink in the refill port 115 after pivoting the cover 120 from the closed position to the opened position to expose the refill portion 111.

As depicted in FIGS. 2-4, the cover 120 includes a handle 123. In the embodiment, the handle 123 is disposed on a side surface of a side portion 121 of a front side of the cover 120 and closer to a lower edge of the side surface. Thus, the user may easily open the cover 120. The handle 123 extends perpendicularly to the pivot axis 120a, and a length of the handle 123 along a right-left direction, i.e., D2 shown in FIG. 2, is smaller than a length of the cover 120 along the right-left direction D2.

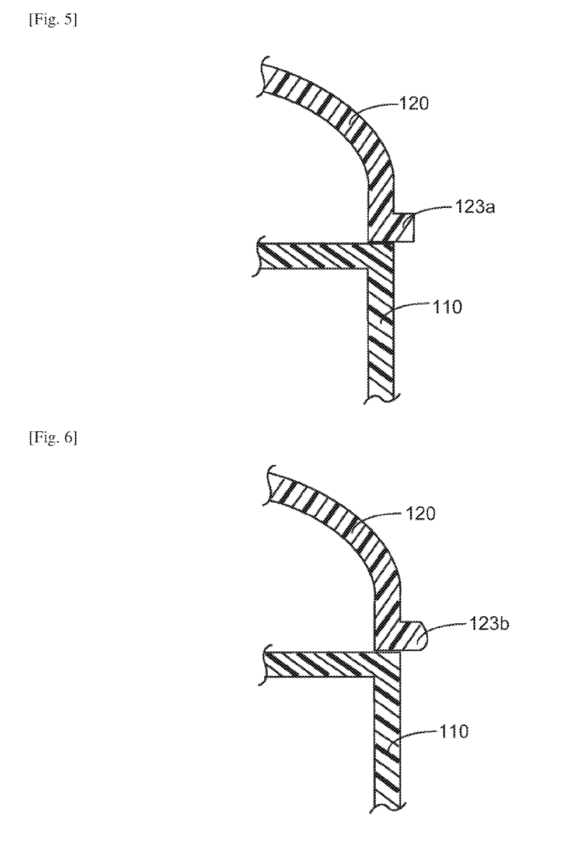

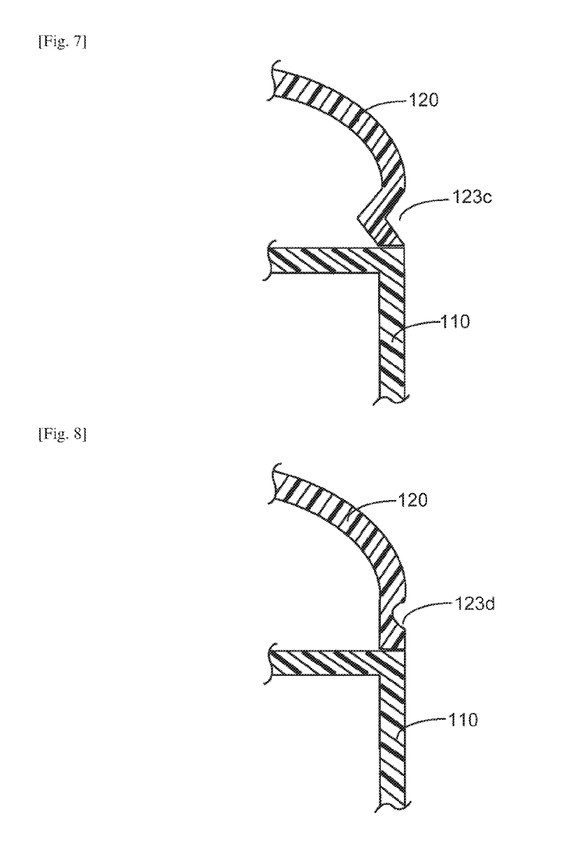

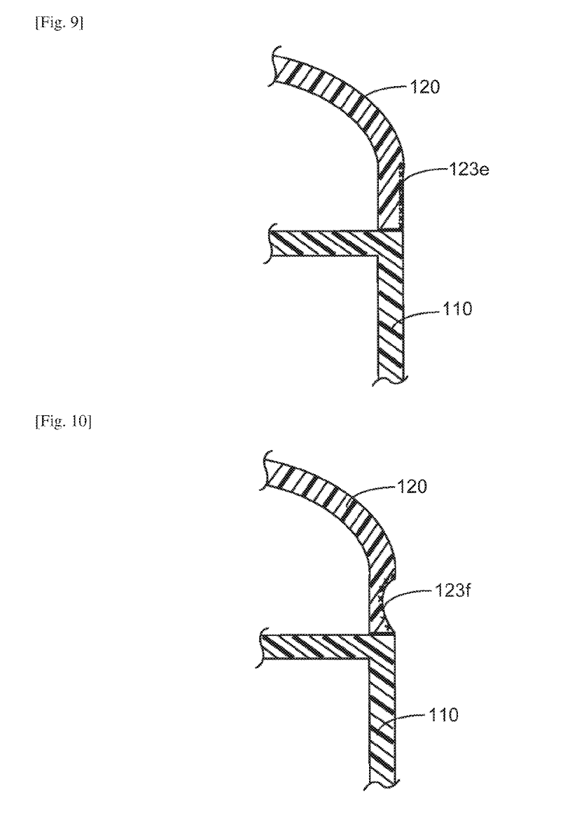

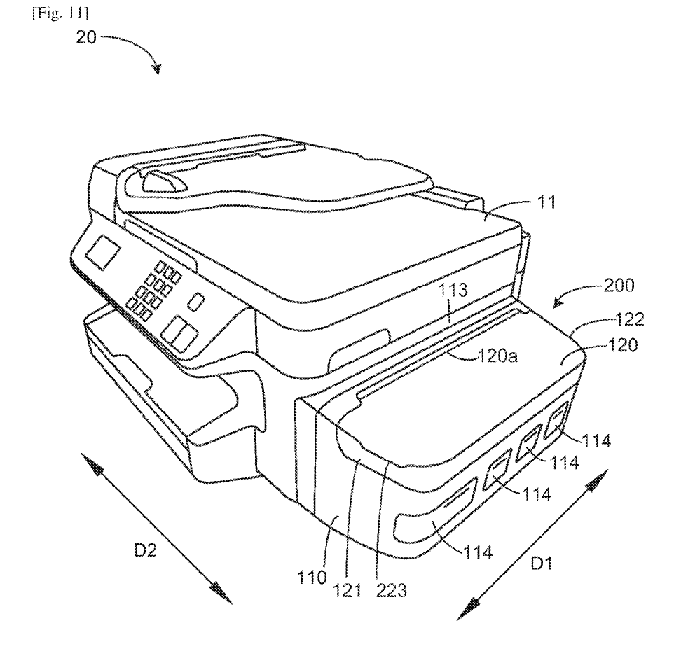

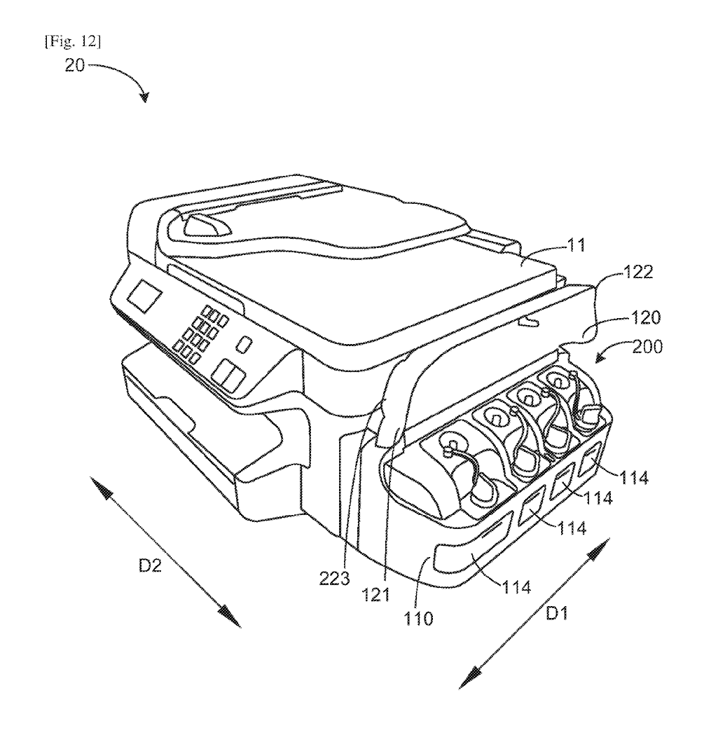

FIG. 5 is an enlarged sectional view of a portion A taken along a line V-V in FIG. 2, and FIGS. 6-10 illustrate other embodiments. In order to enable the user to easily hold the handle 123 and to pivot the cover 120 to the opened position, the handle 123 may have a protruding portion 123a, 123b, as depicted in FIGS. 5 and 6. This configuration enables the user to open the cover 120 more easily by lifting the protruding portion 123a, 123b. An end portion of the protruding portion 123a may have a flat surface, as depicted in FIG. 5, and an end portion of the protruding portion 123b may have a curved surface, as depicted in FIG. 6. In other embodiments, the handle 123 may have a recess portion 123c, 123d, as depicted in FIGS. 7 and 8. The recess portion 123c may have straight surfaces, as depicted in FIG. 7, and the recess portion 123d may have a curved surface, as depicted in FIG. 8. In other embodiments, the handle 123 may have a rough surface 123e, 123f, as depicted in FIGS. 9 and 10, to increase a frictional force between the user's finger and the handle 123. Specifically, as a handle, a part of a surface of the cover 120 may be a rough surface 123e, as illustrated in FIG. 9, instead of having a specific shape of a handle. Alternatively, at least a part of a surface of a recess portion of the cover 120 may be a rough surface 123f, as illustrated in FIG. 10.

The configuration in the embodiment, in which a handle is disposed on the side surface of the front side of the cover, may enable the user to easily open the cover from the front side of the inkjet printer, thereby increasing the variety of operations and facilitating the user's operation.

Other embodiments of the disclosure will be described.

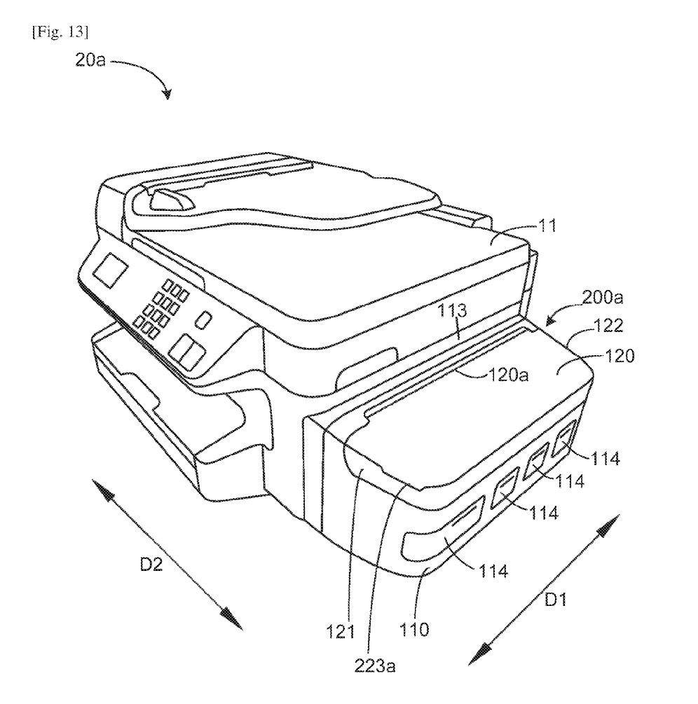

In the embodiments depicted in FIGS. 2-10, the handle 123 is disposed closer to the lower edge of the side surface of the side portion 121. However, in another embodiment depicted in FIGS. 11 and 12, a handle 223 is disposed closer to an upper edge of the side surface of the side portion 121. The remaining configurations may be the same as those shown in FIGS. 2-10.

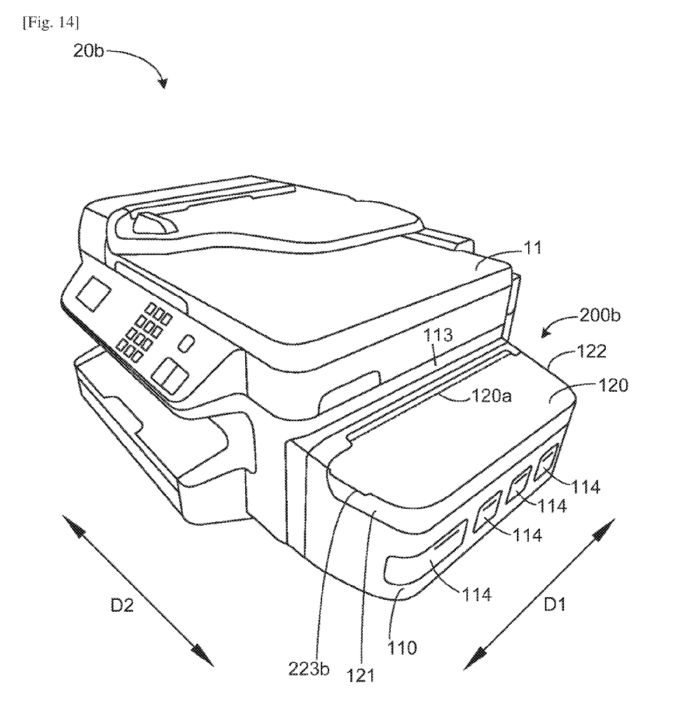

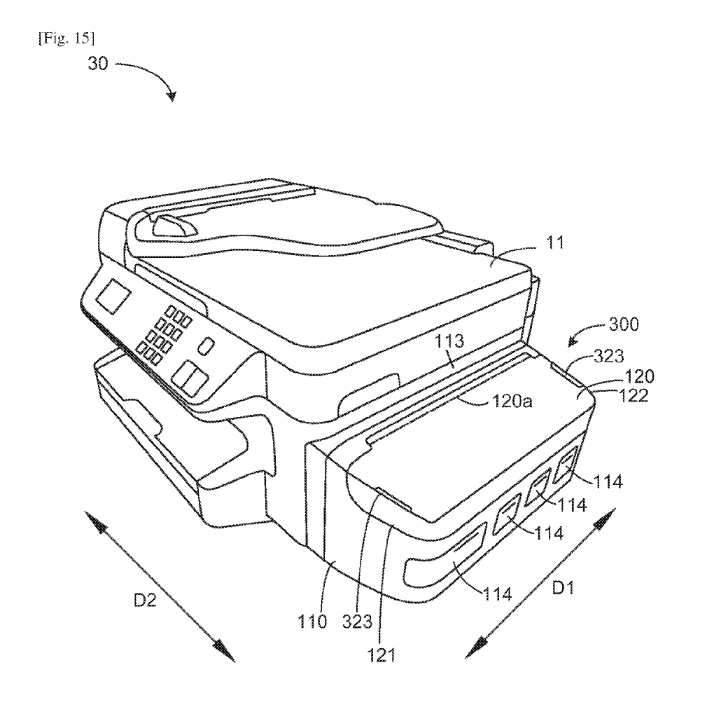

Further, in the embodiment depicted in FIGS. 11 and 12, the handle 223 is disposed on a central portion, in the right-left direction D2, of the side surface of the side portion 121. However, in another embodiment depicted in FIG. 13, a handle 223a is disposed closer to a right side of the ink container 200a in the right-left direction D2, that is, the handle 223a is disposed on a side away from the pivot axis 120a of the cover 120 with respect to the central portion. In another embodiment depicted in FIG. 14, a handle 223b is disposed closer to a left side of the ink container 200b in the right-left direction D2, that is, the handle 223b is disposed on a side closer to the pivot axis 120a of the cover 120 with respect to the central portion. The remaining configurations may be the same as those shown in FIGS. 11 and 12.

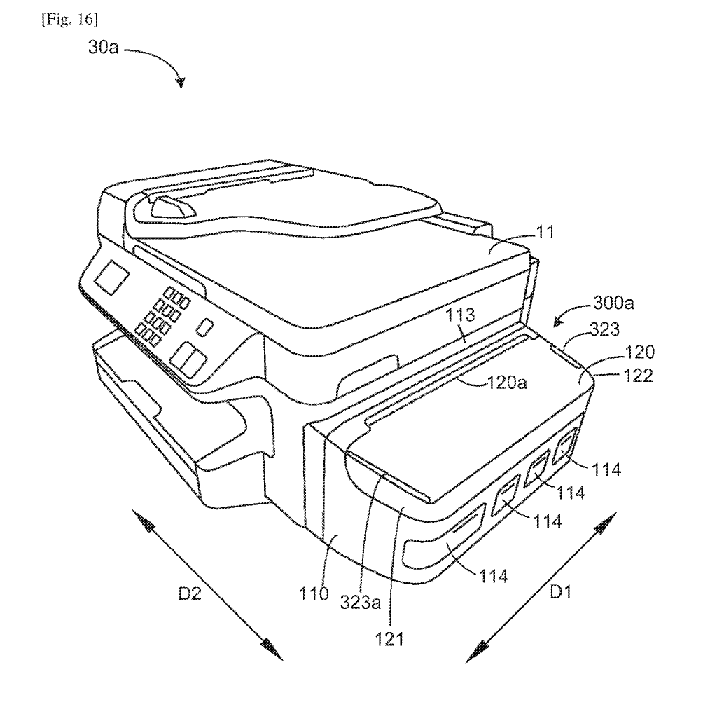

In the embodiment depicted in FIG. 15, the cover 120 includes two handles 323, each of which is disposed on a side portion 121 closer to the front side of the upper surface of the cover 120 and on a side portion 122 closer to the rear side of the upper surface of the cover 120, respectively. This configuration enables the user to open the cover 120 from both the front side and the rear side of the inkjet printer 30.

In the embodiment depicted in FIG. 16, a length of a handle 323a along the D2 direction is equal to a length of the cover 120 along the D2 direction. This configuration may increase an area which the user contacts the handle and enable the user to open the cover with more stability. In FIG. 16, the handle 323a disposed on the side portion 122 of the rear side is equal to the handle depicted in FIG. 15, and a length of the handle 323 along the D2 direction is shorter than the length of the cover 120 along the D2 direction. However, in FIG. 16, the length of the handle 323 may be equal to the length of the handle 323a.

While the disclosure has been described in detail with reference to the specific embodiments thereof, these are merely examples, and various changes, arrangements and modifications may be applied therein without departing from the spirit and scope of the disclosure.

1. An ink container for an inkjet printer, the inkjet printer including a printer body, the ink container comprising:
an ink container body configured to contain ink to be supplied to the printer body and including a refill portion through which ink is refilled; and
a cover configured to cover at least an area of the ink container body in which the refill portion is disposed and to pivot about a pivot axis between an opened position and a closed position with respect to the ink container body such that when the cover is in the closed position, the refill portion is covered by the cover, when the cover is in the opened position, the refill portion is exposed, the pivot axis extending along a horizontal direction and being parallel to an attaching surface, to which the ink container is to be attached, of the printer body, wherein
at least one of two side portions, which are opposite each other along the pivot axis, of the cover includes a handle.

2. The ink container according to claim 1, wherein a length of the handle which is perpendicular to the pivot axis and is along the horizontal direction is equal to a length of the cover which is perpendicular to the pivot axis and is along the horizontal direction.

3. The ink container according to claim 1, wherein a length of the handle which is perpendicular to the pivot axis and is along the horizontal direction is shorter than a length of the cover which is perpendicular to the pivot axis and is along the horizontal direction.

4. The ink container according to claim 1, wherein each of both side portions of the cover includes a side surface, and the handle is disposed on the side surface.

5. The ink container according to claim 4, wherein the handle is disposed closer to one of a lower edge and an upper edge of the side surface.

6. The ink container according to claim 1, wherein the cover has an upper surface, and the handle is disposed closer to the side portion of the upper surface.

7. The ink container according to claim 1, wherein each of both side portions of the cover includes a handle.

8. The ink container according to claim 1, wherein the handle has a rough surface.

9. The ink container according to claim 1, wherein the handle has a protruding portion or a recess portion.

10. An inkjet printer comprising an ink container of claim 1.

11. An ink jet printer comprising:
a printer body having a particular surface;
an ink container body located on the particular surface, the ink container body including an ink tank and a refill portion communicated with the ink tank; and
a cover pivotable about a pivot axis between an opened position and a closed position with respect to the ink container body, wherein
when the cover is in the closed position, the refill portion is covered by the cover,
when the cover is in the opened position, the refill portion is exposed,
the pivot axis extends along a horizontal direction and is parallel to the particular surface,
the cover has two side portions, one side portion being opposite to the other side portion along the pivot axis, and
the cover has a handle at one of the two side portions.

12. The ink jet printer according to claim 11, wherein the cover has the handle at the one side portion and another handle at the other side portion.
